(19) United States
(12) Patent Application Publication
(10) Pub. No.: US 2016/0286510 A1
(43) Pub. Date: Sep. 29, 2016

(54) METHODS AND SYSTEMS FOR SYNCHRONIZING A COMMUNICATION NODE IN A COMMUNICATION NETWORK

(71) Applicants: Said Soulhi, Mansfield, MA (US); Jan Devai, Laval (CA); TELEFONAKTIEBOLAGET L M ERICSSON ( PUBL), Stockholm (SE)

(72) Inventors: Said Soulhi, Mansfield, MA (US); Jan Devai, Laval, Quebec (CA)

(73) Assignee: TELEFONAKTIEBOLAGET L M ERICSSON (PUBL), Stockholm (SE)

(21) Appl. No.: 14/409,830

(22) PCT Filed: Oct. 31, 2014
(86) PCT No.: PCT/IB2014/065753

§ 371 Date: Jan. 12, 2015

(51) Int. Cl. H04W 56/00; H04W 12/08; H04L 29/06

(52) U.S. Cl. CPC H04W 56/0015; H04L 63/10; H04W 12/08; H04L 63/1441; H04L 63/1416

(57) ABSTRACT

Methods and related systems for synchronizing a communication node in a communication network are provided. The methods generally involve the request and transmission of the local clock of a neighboring communication node for use at the communication node instead of using the clock information of the external clock source, at least for a predetermined amount of time. By using the clock of a neighboring communication node, a communication node which local clock cannot be based on an external source, because it is unavailable or has become corrupted, can remain synchronized with the other communication nodes in the communication network.

### TECHNICAL FIELD

The present invention generally relates to wireless telecommunication networks and more particularly relates to synchronization in wireless telecommunication networks.

### BACKGROUND

In certain mobile communication networks, synchronization among the various base stations providing network access to mobile terminals (e.g. user equipment) is required. Synchronization among base stations allows the mobile communication network to provide services such as broadcasting.

One common way to synchronize multiple base stations deployed over a large geographical area is to use the clock information contained in signals transmitted by Global Navigation Satellite Systems (GNSS) (e.g. GPS, Galileo, Glonass, etc.). In that sense, satellites from such GNSS regularly broadcast signals which comprise various types of information, including clock information, used by GNSS receivers (e.g. GPS receivers) to determine their geographical positions. As these GNSS signals are broadcasted over wide geographical areas, they can be used by the base stations for synchronization purposes.

However, there are some shortcomings with using GNSS signals for synchronization purposes.

To begin with, in some wireless communication networks, some base stations are located indoor (e.g. inside buildings). Since GNSS signals cannot travel through buildings, these indoor base stations cannot receive the GNSS signals and therefore cannot use these signals for synchronization purposes.

Furthermore, using GNSS signals transmitted by GNSS satellites for synchronization purposes assumes that the signals received by the base stations are genuine or otherwise not corrupted. In the event that the local clock of one or more base stations becomes corrupted, synchronization among base stations will be lost.

In that sense, it has been found to be relatively easy to generate and transmit intentionally corrupted or fake GNSS signals, i.e. GNSS signals comprising false coordinates and/or false clock information, in order to disrupt one or more base stations and possibly part of the communication network.

When the synchronization of a base station is based on false clock information, several services can be disrupted or even unavailable.

Therefore, it would be desirable to provide methods and systems that obviate or mitigate the above described problems.

### SUMMARY

It is an object of the present invention to obviate or mitigate at least one disadvantage of the prior art.

In accordance with one broad aspect of the present invention, there are provided methods and related systems for synchronizing a communication node (e.g. base station, eNB, etc.) in a communication network in the event that the external signals from which the local clock of the communication node is generally based or otherwise retrieved is either unavailable (e.g. the base station is indoor) or becomes corrupted (e.g. the base station is under a synchronization attack). The method generally involves requesting and using the local clock of a neighboring communication node instead of using the clock information of the external clock source, at least for a predetermined amount of time.

According to an exemplary embodiment, a method to synchronize a communication node, generally part of a cluster of communication nodes in a wireless communication network, generally comprises, at the communication node, transmitting a clock synchronization request to a neighboring reference communication node part of the cluster, the synchronization request generally comprising the most recent local clock value of the communication node, receiving a clock synchronization response from the neighboring reference communication node, the clock synchronization response comprising a clock value of the neighboring reference communication node, and replacing the most recent local clock value with the clock value of the neighboring reference communication node.

In such embodiments, when the requesting communication node is out of range of the external source of clock (e.g. GNSS signals), the requesting communication node will generally regularly transmit a clock synchronization request to the neighboring reference communication node in order to maintain its synchronization.

In some embodiments, the local clock of the neighboring reference communication node received by the communication node can be further adjusted to take into account the transmission delay between the transmission of the clock synchronization request and the reception of the clock synchronization response. In further embodiments, the adjusted clock value of the communication node can be further compared to the clock value of the neighboring reference communication node to validate the synchronization between the two nodes. Such further validation may comprise transmitting a further clock synchronization request to the neighboring reference communication node, the further clock synchronization request comprising the adjusted clock value of the communication node, and receiving a further clock synchronization response from the neighboring reference communication node. The content of the further clock synchronization response may vary depending, for instance, on whether the synchronization was successful or not.

According to another exemplary embodiment, a method to synchronize a communication node, generally part of a cluster of communication nodes in a wireless communication network, generally comprises, at a neighboring reference communication node part of the cluster, receiving a clock synchronization request from the requesting communication node needing synchronization, the clock synchronization request generally comprising the most recent clock value of the requesting communication node, transmitting a clock synchronization response to the requesting communication node, the clock synchronization response comprising the local clock value of the neighboring reference communication node.

In some embodiments, the method may further comprise determining if the most recent clock value of the requesting communication node differs from the local clock value of the neighboring reference communication node beyond a predetermined threshold.

According to another exemplary embodiment, there is provided a communication node comprising a synchronization request transmitting module for transmitting a synchronization request to a neighboring reference communication node, a synchronization response receiving module for receiving a synchronization response from the neighboring reference communication node, and a local clock replacing module for replacing the local clock value of the communication node with the clock value of the neighboring reference communication node.

According to another exemplary embodiment, there is provided a communication node comprising a synchronization request receiving module for receiving a synchronization request from a requesting communication node, and a synchronization response transmitting module for transmitting a synchronization response to the requesting communication node.

According to another exemplary embodiment, a method to synchronize a communication node, generally part of a cluster of communication nodes in a wireless communication network, generally comprises detecting a loss of clock synchronization of a local clock value, transmitting a clock synchronization request to a neighboring reference communication node part of the cluster, the synchronization request comprising the most recent (and possibly corrupted) local clock value, receiving a clock synchronization response from the neighboring reference communication node, the clock synchronization response comprising a clock value of the neighboring reference communication node, and replacing the most recent local clock value with the clock value of the neighboring reference communication node.

In some embodiments, detecting the loss of clock synchronization of the local clock value generally comprises determining an average time difference between consecutively received clock values, determining a current time difference between the most recently received clock value and the previously received clock value, comparing the current time difference with the average time difference, and detecting a loss of synchronization if the current time difference differs from the average time difference by more than a predetermined threshold. Typically, the received clock values are retrieved from signals transmitted by GNSS satellites. However, the received clock values could additionally or alternatively be received from any other appropriate external sources (e.g. Network Time Protocol server, a Transport Network, etc.).

Since external clock sources (e.g. GNSS signals) are usually reliable, in the event the communication node detects a loss of clock synchronization, the communication node can conclude that it is under a synchronization attack. In such a scenario, the loss of clock synchronization will most likely be due to the reception, by the communication node, of one or more corrupted clock values transmitted by an attacking transmitter. In such embodiments, the method may further comprise transmitting a synchronization attack notification to all neighboring communication nodes and/or blocking the reception of further corrupted clock values from the attacking transmitter.

In some embodiments, the local clock of the neighboring reference communication node received by the communication node can be further adjusted to take into account the transmission delay between the transmission of the clock synchronization request and the reception of the clock synchronization response. In further embodiments, the adjusted clock value of the communication node can be further compared to the clock value of the neighboring reference communication node to validate the synchronization between the two nodes. Such further validation may comprise transmitting a further clock synchronization request to the neighboring reference communication node, the further clock synchronization request comprising the adjusted clock value of the communication node, and receiving a further clock synchronization response from the neighboring reference communication node. The content of the further clock synchronization response may vary depending, for instance, on whether the synchronization was successful or not.

According to another exemplary embodiment, a method to synchronize a communication node, generally part of a cluster of communication nodes in a wireless communication network, generally comprises, at a neighboring reference communication node part of the cluster, receiving a clock synchronization request from the communication node needing synchronization, the clock synchronization request comprising the most recent (and possibly corrupted) clock value, determining if the most recent clock value differs from the local clock value of the neighboring reference communication node beyond a predetermined threshold, as a function of the determination, transmitting a clock synchronization response to the requesting communication node, the clock synchronization response comprising the local clock value if the most recent clock value differs from the local clock value beyond the predetermined threshold, or transmitting a clock synchronization failure notification to the communication node if the most recent clock value does not differ from the local clock value beyond the predetermined threshold.

In some embodiments, the clock synchronization failure notification will comprise an indication that the most recent clock value transmitted by the communication node in the clock synchronization request is in fact not corrupted or otherwise not desynchronized. In some embodiments, the neighboring reference communication node may further transmit a synchronization attack notification to other neighboring communication nodes in the cluster if the neighboring reference communication node determines that the most recent clock value differs from the local clock value beyond the predetermined threshold. This synchronization attack notification may be used by the other neighboring communication nodes for synchronization attack monitoring purposes.

In some embodiments, the neighboring reference communication node may itself detect a loss of synchronization of its own local clock. In such embodiment, the method may further comprise transmitting a clock synchronization failure notification to the communication node. This clock synchronization failure notification would generally comprise an indication that the neighboring reference communication node is unable to provide clock synchronization to the requesting communication node since the neighboring reference communication node has itself lost its synchronization.

According to another exemplary embodiment, there is provided a communication node comprising a loss of synchronization detecting module responsible for detecting a loss of synchronization of a local clock of the communication node, a synchronization request transmitting module for transmitting a synchronization request to a neighboring reference communication node, a synchronization response receiving module for receiving a synchronization response from the neighboring reference communication node, and a local clock replacing module for replacing the local clock value of the communication node with the clock value of the neighboring reference communication node.

According to another exemplary embodiment, there is provided a communication node comprising a synchronization request receiving module for receiving a synchronization request from a requesting communication node having possibly lost its synchronization, a clock comparing module for comparing a clock received in the synchronization request with the local clock of the communication node, and a synchronization response transmitting module for transmitting a synchronization response to the requesting communication node.

According to another exemplary embodiment, there is provided a communication node comprising a communication interface and circuitry operatively connected to the communication interface. The communication interface is configuration to transmit and receive signals from one or more networks. The circuitry is adapted to perform one or more of the aforementioned methods. In some embodiments, the circuitry comprises a processor and memory.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a diagram of an exemplary network in accordance with embodiments of the present invention in which at least one communication node is located indoor.

FIG. 2 is a message flow and signaling diagram illustrating a method for synchronizing a communication node in accordance with an exemplary embodiment.

FIG. 3 is a flowchart illustrating a method for synchronizing a communication node in accordance with an exemplary embodiment, as performed by a requesting communication node.

FIG. 4 is another flowchart illustrating a method for synchronizing a communication node in accordance with an exemplary embodiment, as performed by a requesting communication node.

FIG. 5 is a flowchart illustrating a method for synchronizing a communication node in accordance with an exemplary embodiment, as performed by a reference communication node.

FIG. 6 is another flowchart illustrating a method for synchronizing a communication node in accordance with an exemplary embodiment, as performed by a reference communication node.

FIG. 7 is a block diagram of a communication node in accordance with an exemplary embodiment.

FIG. 8 is another block diagram of a communication node in accordance with an exemplary embodiment.

FIG. 9 is a diagram of an exemplary network in accordance with embodiments of the present invention in which at least one communication node is under a synchronization attack.

FIGS. 10A, 10B and 10C are message flow and signaling diagrams illustrating methods for synchronizing a communication node in accordance with an exemplary embodiment.

FIG. 11 is a flowchart illustrating a method for synchronizing a communication node in accordance with an exemplary embodiment, as performed by a requesting communication node.

FIG. 12 is another flowchart illustrating a method for synchronizing a communication node in accordance with an exemplary embodiment, as performed by a requesting communication node.

FIG. 13 is a flowchart illustrating a method for detecting a loss of synchronization in accordance with an exemplary embodiment.

FIG. 14 is a flowchart illustrating a method for selecting a neighboring reference communication node in accordance with an exemplary embodiment.

FIG. 15 is a flowchart illustrating a method for synchronizing a communication node in accordance with an exemplary embodiment, as performed by a reference communication node.

FIG. 16 is another flowchart illustrating a method for synchronizing a communication node in accordance with an exemplary embodiment, as performed by a reference communication node.

FIG. 17 is a diagram of the exemplary network of FIG. 9 in which several communication nodes are under a synchronization attack.

FIG. 18 is a message flow and signaling diagram illustrating a method for synchronizing a communication node in accordance with an exemplary embodiment.

FIG. 19 is another flowchart illustrating a method for synchronizing a communication node in accordance with an exemplary embodiment, as performed by a reference communication node.

FIG. 20 is a block diagram of a communication node in accordance with an exemplary embodiment.

FIG. 21 is another block diagram of a communication node in accordance with an exemplary embodiment.

FIG. 22 is another block diagram of a communication node in accordance with an exemplary embodiment.

### DETAILED DESCRIPTION

The present invention is directed to methods and systems for synchronizing a communication node in a communication network.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

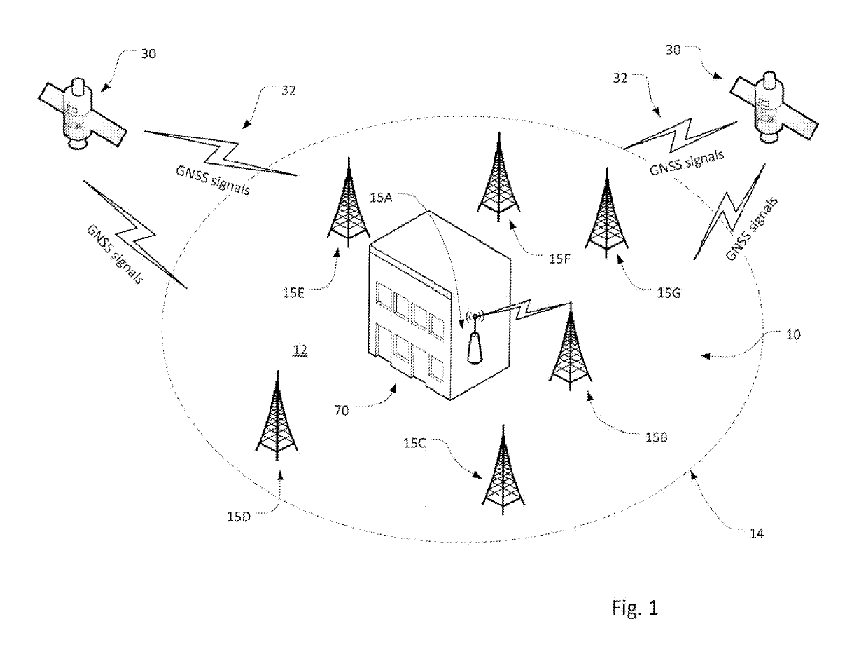

Referring first to FIG. 1, an example of a mobile communication network 10 in which embodiments of the present invention can be deployed is depicted. The communication network 10 is generally configured to provide wireless communication to user equipment (UE), not shown for clarity. In that sense, communication network 10 generally comprises a plurality of communication nodes 15 which are deployed over a geographical area 12. In the present embodiment, the communication nodes 15 are embodied as base stations (BS) 15 (e.g. eNB) in the wireless communication network 10. Groups of base stations 15 deployed over a particular area 12 generally form clusters 14 of base stations 15. Also, in the present embodiment, at least one base station 15 (i.e. base station 15A) is located indoor, that is inside a building 70.

In order to provide certain services to the UEs, the base stations 15 need to be synchronized, i.e. they need to use the same time reference. In the present embodiment, in order to be synchronized among them, most of the base stations 15 retrieve clock information from GNSS signals 32 transmitted by GNSS satellites 30. Though only two GNSS satellites 30 are shown, typical GNSS comprises a plurality of GNSS satellites 30. By using the clock information comprises in GNSS signals 32, the base stations 15 can be properly synchronized as they use the same clock information retrieved from the same external source (e.g. the GNSS satellites 30).

However, in the present embodiment, base station 15A which is located indoor cannot receive the GNSS signals 32 transmitted by GNSS satellites 30. Hence, base station 15A cannot use the clock information from the GNSS signals 32 for synchronization. In the present embodiment, base station 15A relies on an outdoor base station 15 (e.g. base station 15B) for synchronization. Such a scenario can happen for instance in a HETNET deployment in a dense area where there are multiple cell types: picocell, microcell and macrocell). The present embodiment can be used to provide GNSS synchronization to indoor base stations from outdoor base stations. For example, a picocell in a building will not be able to capture the GNSS signals due to lack of coverage.

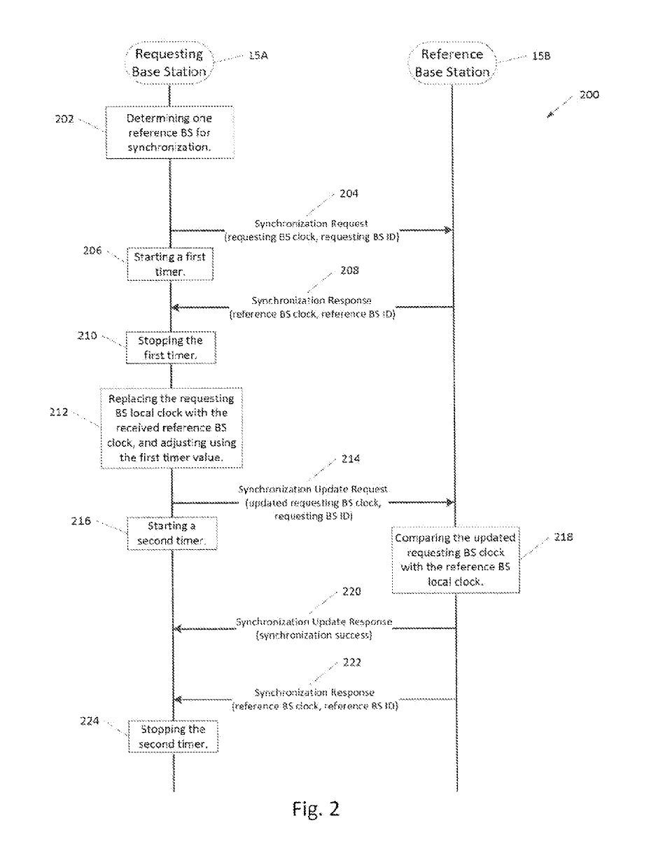

Referring now to FIG. 2, an exemplary message flow and signaling diagram 200 according to an embodiment of the present invention will now be described. In the embodiment 200, base station 15A first retrieves, at 202, at least one neighboring and outdoor reference base station 15 to communicate with for synchronization purposes. Once base station 15A has retrieved one outdoor reference base station 15, e.g. outdoor reference base station 15B in FIG. 1, base station 15A transmits, at 204, a clock synchronization request to reference base station 15B. The clock synchronization request generally comprises identification information of base station 15A (requesting BS ID) and at least the most recent local clock value of base station 15A (requesting BS clock). The clock synchronization request could also comprise other parameters and fields. At about the same time as the transmission of the clock synchronization request, base station 15A starts a tinier at 206.

Once reference base station 15B receives the clock synchronization request from base station 15A, reference base station 15B transmits, at 208, a clock synchronization response to base station 15A. The clock synchronization response generally comprises at least the local clock value of reference base station 15B. The clock synchronization response could also comprise additional information (e.g. identification information of reference base station 15B, flag(s), etc.).

Once base station 15A receives the clock synchronization response, it stops the timer at 210. The timer is generally used to determine a transmission delay between the transmission of the clock synchronization request and the reception of the clock synchronization response. Then, at 212, base station 15A replaces its clock value with the clock value received from reference base station 15B. In the present embodiment, base station 15A further adjusts the replacement clock value with the transmission delay determined with the timer. In that sense, in the present embodiment, the adjustment of the replacement clock value generally involves adding half the transmission delay to the replacement clock value.

Once base station 15A has replaced its clock value with the clock value of base station 15B and has further adjusted the replacement clock value, base station 15A transmits, at 214, a synchronization update request to reference base station 15B. The synchronization update request generally comprises the adjusted (i.e. updated) clock value and identification information of base station 15A. At about the same time as the transmission of the synchronization update request, base station 15A starts a second timer at 216.

At 218, reference base station 15B compares the updated clock value comprised in the synchronization update request with its local clock value. The purpose of this comparison is to validate that the clock value of base station 15A is now properly synchronized with the clock value of base station 15B.

If the clock value comprised in the synchronization update request matches with the local clock value of reference base station 15B, reference base station 15B transmits a synchronization update response or acknowledgement, at 220, to base station 15A. The synchronization update response generally comprises an indication that the synchronization was successful (e.g. a raised synchronization success flag) and possibly the local clock value of reference base station 15B.

Otherwise, if the clock value comprised in the synchronization update request does not match with the local clock value of reference base station 15B, reference base station 15B instead transmits, at 222, a synchronization response, similar to synchronization response sent at 208, which comprises the local time of base station 15B.

In the present embodiment, a mismatch is determined to exist between the two clock values if the two clock values differ by more than a predetermined threshold (e.g. a predetermined time difference, a predetermined percentage, etc.). This predetermined threshold could be settable by the network operator.

Once base station 15A receives either the synchronization update response or the second synchronization response, base station 15A stops the second timer at 224.

At this point, if base station 15A receives a synchronization update response from reference base station 15B, base station 15A concludes that it is properly synchronized with reference base station 15B. Otherwise, if base station 15A receives a regular synchronization response from base station 15B, base station 15A again replaces its local clock value with the clock value comprised in the synchronization response. This twice replaced clock value can be further adjusted with the transmission delay determined with the second timer.

Though not shown in FIG. 2, base station 15A can send a new synchronization update request including the twice updated clock value to again verify that it is now properly synchronized. This validation process can be repeated until either synchronization is achieved or a predetermined number of failed attempts is reached.

In the present embodiment, the first and second timers can also be used to determine occurrences of time-outs. For instance, if base station 15A fails to receive any response from reference base station 15B after a predetermined time-out delay, generally settable by the network operator, base station 15A will retrieve another neighboring base station 15 from its internal list of neighboring base stations, and will transmit the clock synchronization request to that new neighboring reference base station 15. Notably, a time-out can occur when, for instance, the neighboring reference base station 15B has also lost its synchronization or is otherwise unavailable.

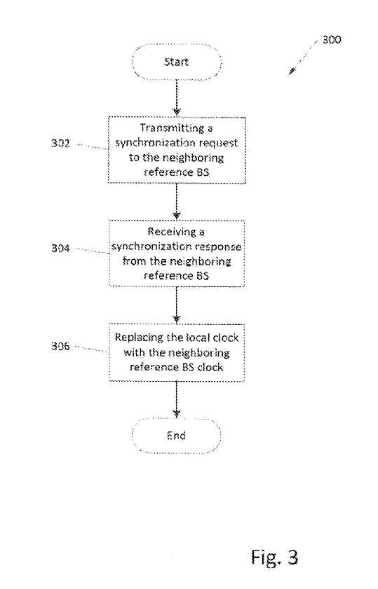

An embodiment of a method for synchronizing a communication node as implemented by a requesting base station 15, i.e. a base station 15 being located indoor or which otherwise cannot receive the GNSS signals 32, is illustrated by the flow chart 300 depicted in FIG. 3.

In flow chart 300, requesting base station 15 generally transmits, at 302, a clock synchronization request to a neighboring and generally outdoor reference base station 15. Then, requesting base station 15 receives, at 304, a synchronization response from reference base station 15, the synchronization response comprising the local clock of the reference base station. Requesting base station 15 then replaces, at 306, its local clock value with the clock value received in the synchronization response.

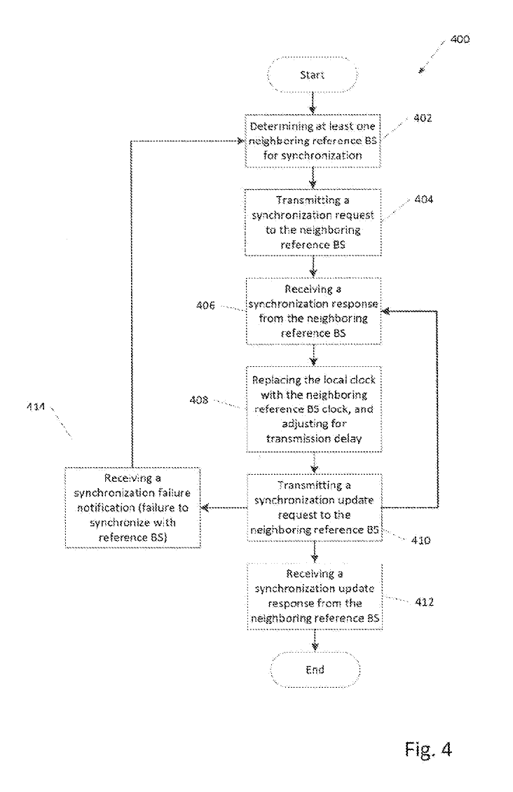

Another embodiment of a method for synchronizing a communication node as implemented by a requesting base station 15 is illustrated by the flow chart 400 depicted in FIG. 4. Embodiment 400 is similar to embodiment 300 but comprises alternative and/or additional steps.

In flow chart 400, requesting base station 15 generally determines, at 402, at least one neighboring and typically outdoor reference base station 15 to contact for synchronization purposes. At 404, requesting base station 15 transmits a clock synchronization request to the previously determined neighboring reference base station 15. Then, at 406, requesting base station 15 receives a synchronization response from reference base station 15. At 408, requesting base station 15 replaces its local clock value with the clock value of reference base station 15, and typically further adjusts the replacement clock value to take into account the transmission delay between the transmission of the request and the reception of the response. In the present embodiment, the adjustment to the clock value generally involves adding half the transmission delay to the replacement clock value of reference base station 15.

In the present embodiment, requesting base station 15 further sends, at 410, a synchronization update request to reference base station 15. The synchronization update request generally comprises the updated local clock of requesting base station 15.

If the updated clock value matches the local clock value of reference base station 15, then requesting base station 15 receives, at 412, a synchronization update response which comprises an indication that synchronization was successful. Otherwise, the procedure loops back to 406 where requesting base station 15 receives another synchronization response with the clock value of reference base station 15.

Requesting base station 15 can try to synchronize its local clock value using the local clock value of reference base station 15 for a predetermined number of times. In that sense, if requesting base station 15 fails to properly synchronize its local clock value with the clock value of reference base station 15, it will eventually receive, at 414, a synchronization failure notification comprising an indication that synchronization with reference base station 15 has failed. At that point, the method will loop back to 402 and requesting base station 15 will try again with another neighboring reference base station 15.

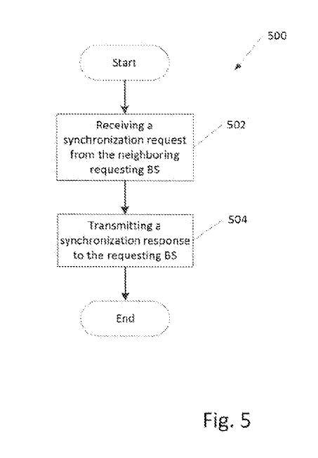

An embodiment of a method for synchronizing a communication node as implemented by a reference base station 15 is illustrated by the flow chart 500 depicted in FIG. 5.

At 502, reference base station 15 receives a clock synchronization request from a requesting base station 15. As indicated above, the clock synchronization request generally comprises the most recent local clock value of requesting base station 15.

Then, at 504, reference base station 15 transmits a clock synchronization response to requesting base station 15, the clock synchronization response comprising the local clock value of reference base station 15.

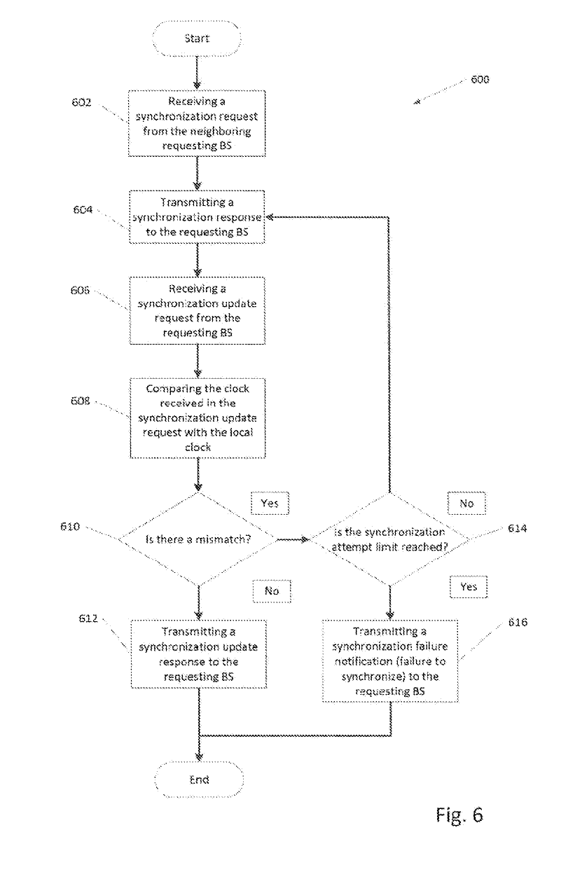

Another embodiment of a method for synchronizing a communication node as implemented by a reference base station 15 is illustrated by the flow chart 600 depicted in FIG. 6. Embodiment 600 is similar to embodiment 500 but comprises alternative and/or additional steps.

Starting at 602, reference base station 15 receives a clock synchronization request from a requesting base station 15. Again, the clock synchronization request generally comprises the most recent local clock value of requesting base station 15.

Then, at 604, reference base station 15 transmits a clock synchronization response to requesting base station 15, the clock synchronization response comprising the local clock value of reference base station 15.

Then, reference base station 15 receives, at 606, a clock synchronization update request from requesting base station 15, the clock synchronization update request generally comprising the updated clock value of requesting base station 15. At 608, reference base station 15 compares the received updated clock value with its own local clock value to determine if there is a mismatch.

If there is no mismatch, reference base station 15 transmits, at 612, a clock synchronization response or acknowledgement indicating that synchronization has succeeded.

Otherwise, if there is a mismatch, reference base station 15 determines, at 614, whether reference base station 15 has reached the limit of synchronization attempts. This limit of synchronization attempts generally prevents reference base station 15 from trying indefinitely to provide synchronization to requesting base station 15.

If the limit is reached, reference base station 15 transmits, at 616, a clock synchronization failure notification generally comprising an indication that synchronization has failed (e.g. a raised failed attempts limit reached flag).

If the limit is not yet reached, reference base station 15 loops back to 604 and again transmits a synchronization response to requesting base station 15.

To perform one or more of the methods described in accordance with the present invention, embodiments of the base station 15 can comprise various modules.

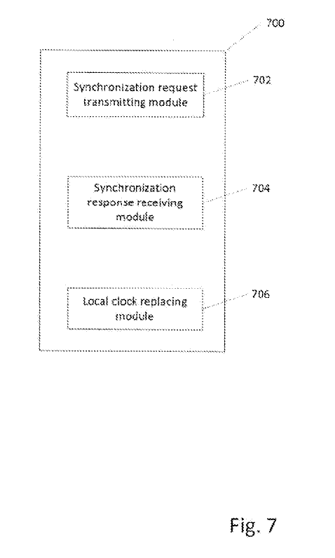

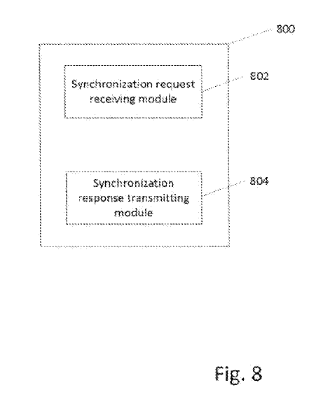

Such combinations or groups of modules are illustrated as embodiments 700 and 800 in FIGS. 7 and 8 respectively.

In FIG. 7, the group 700 of modules generally comprises a synchronization request transmitting module 702 for transmitting a synchronization request to a neighboring reference base station 15, a synchronization response receiving module 704 for receiving the synchronization response from the neighboring reference base station 15, and a local clock replacing module 706 for replacing the local clock value of the base station 15 with the clock value of the neighboring reference base station 15.

In FIG. 8, the group 800 of modules generally comprises a synchronization request receiving module 802 for receiving a synchronization request from a requesting base station 15 needing synchronization, and a synchronization response transmitting module 804 for transmitting a synchronization response to requesting base station 15.

Understandably, depending on its location (e.g. indoor or outdoor) as a base station 15 can possibly act both as a requesting base station 15 and as a reference base station 15 depending on the circumstances. Hence, a base station 15 may comprise a combination of both groups of modules 700 and 800.

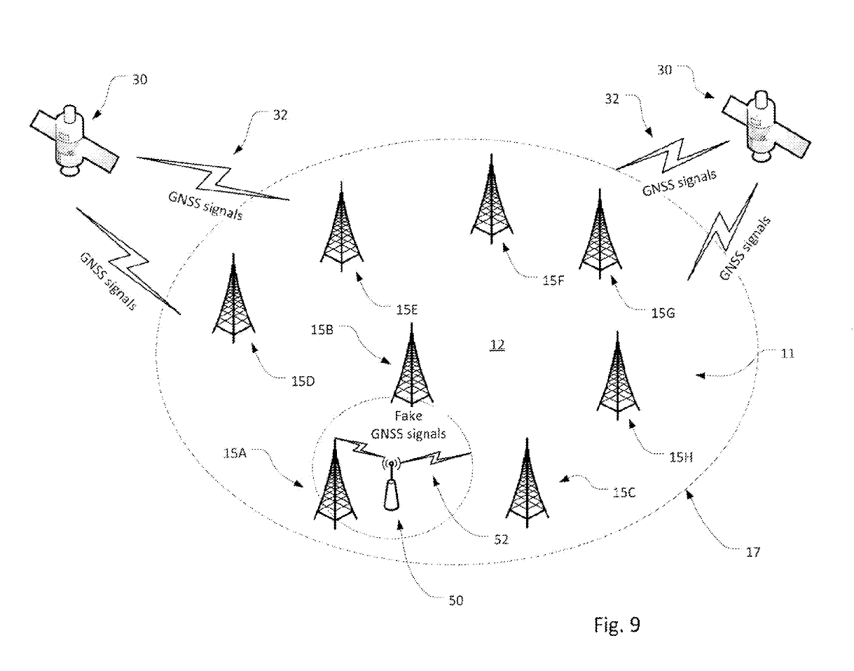

Referring now to FIG. 9, another embodiment of a mobile communication network 11 in which the present invention can be deployed is depicted. The communication network 11 is similar to communication network 10. Still, in communication network 11, all the communication nodes 15 are located outdoor. In the present embodiment, the communication nodes 15 are also embodied as base stations (BS) 15 (e.g. eNB).

In the present embodiment, synchronization among the base stations 15 is based on the assumption that each and every base station 15 regularly retrieves the same common clock information from the GNSS signals 32. In the event that one or more base stations 15 either fail to receive the GNSS signals 32 or receive corrupted signals 32, synchronization among the base stations 15 can be lost.

Such an event can occur when an attacking transmitter 50 transmits fake GNSS signals 52, i.e. signals comprising false geographical and/or false clock information, in order to disrupt the synchronization of one or more base stations 15. In FIG. 9, the attacking transmitter 50 transmits fake GNSS signals 52 near base station 15A.

If base station 15A starts using the clock information contained in the fake GNSS signals 52, it will no longer be synchronized with the other base stations 15. This, in turn, will prevent base station 15A from providing at least certain services which require synchronization with the other base stations 15 (e.g. voice calls, web browsing, broadcasting, hand-over, etc.).

In accordance with an embodiment, when a base station 15 detects that it is receiving fake or otherwise corrupted GNSS signals 52, it will synchronize its clock using the clock of a neighboring reference base station 15, e.g. base station 15B in FIG. 1.

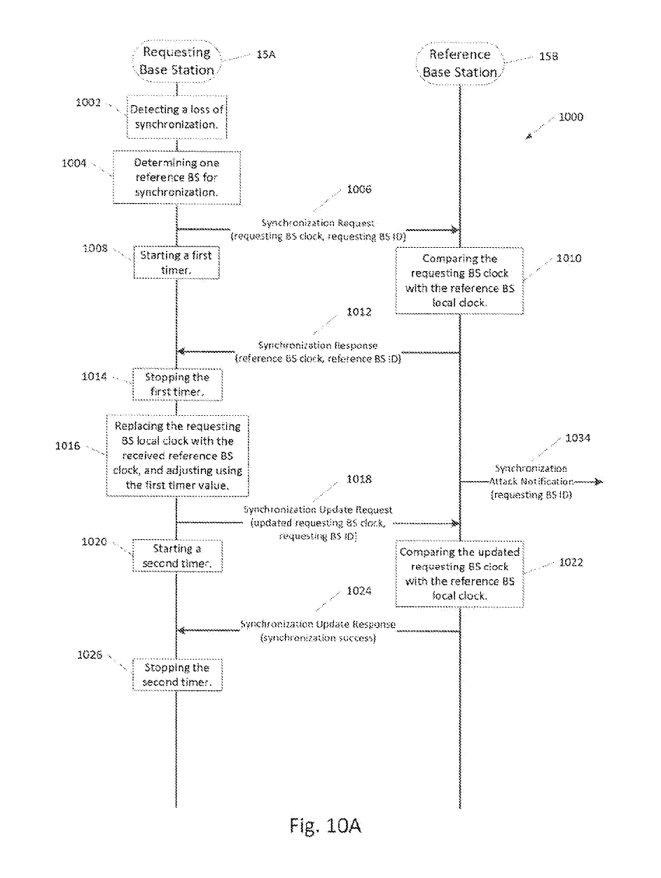

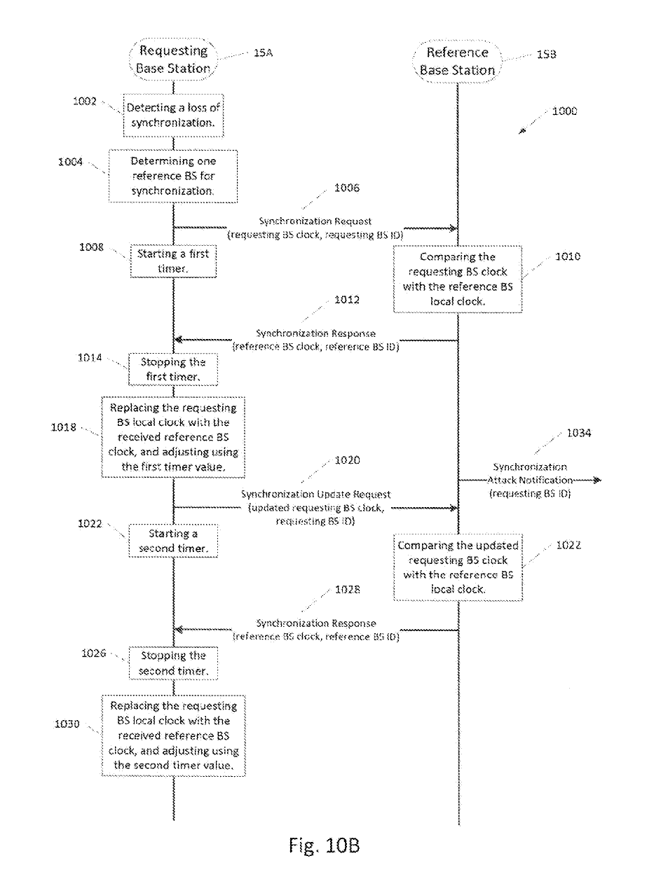

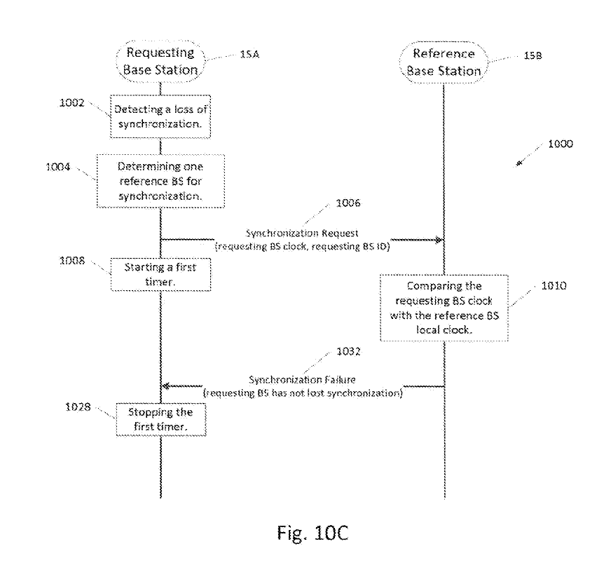

Referring now to FIGS. 10A, 10B and 10C, an exemplary message flow and signaling diagram 1000 according to an embodiment of the present invention will now be described. In the embodiment 1000, base station 15A first detects a loss of clock synchronization at 1002. Then, at 1004, base station 15A retrieves at least one neighboring reference base station 15 to communicate with for synchronization purposes. Once base station 15A has retrieved one neighboring reference base station 15, e.g. reference base station 15B in FIG. 9, base station 15A transmits, at 1006, a clock synchronization request to reference base station 15B. The clock synchronization request generally comprises identification information of base station 15A (requesting BS ID) and at least the most recent local clock value of base station 15A (requesting BS clock). The clock synchronization request could also comprise other parameters and fields such as an alarm flag. At about the same time as the transmission of the clock synchronization request, base station 15A starts a timer at 1008.

Once reference base station 15B receives the clock synchronization request from base station 15A, reference base station 15B compares, at 1010, the received clock value with its own local clock value. If there is a mismatch between the two clock values, reference base station 15B transmits, at 1012, a clock synchronization response to base station 15A. The clock synchronization response generally comprises at least the local clock value of reference base station 15B. The clock synchronization response could also comprise additional information (e.g. identification information of reference base station 15B, flag(s), etc.).

In the present embodiment, a mismatch is determined to exist between the two clock values if the two clock values differ by more than a predetermined threshold (e.g. a predetermined time difference, a predetermined percentage, etc.). This predetermined threshold could be settable by the network operator.

Once base station 15A receives the clock synchronization response, it stops the tinier at 1014. The timer is generally used to determine a transmission delay between the transmission of the clock synchronization request and the reception of the clock synchronization response. Then, at 1016, base station 15A replaces its clock value with the clock value received from reference base station 1511. In the present embodiment, base station 15A further adjusts the replacement clock value with the transmission delay determined with the timer. In that sense, in the present embodiment, the adjustment of the replacement clock value generally involves adding half the transmission delay to the replacement clock value.

In the present embodiment, once base station 15A has replaced its corrupted clock value with the clock value of base station 15B and has further adjusted the replacement clock value, base station 15A transmits, at 1018, a synchronization update request to reference base station 15B. The synchronization update request generally comprises the adjusted (i.e. updated) clock value and identification information of base station 15A. At about the same time as the transmission of the synchronization update request, base station 15A starts a second timer at 1020.

At 1022, reference base station 15B compares the updated clock value comprised in the synchronization update request with its local clock value. The purpose of this second comparison is to validate that the clock value of base station 15A is now properly synchronized with the clock value of base station 15B.

If the clock value comprised in the synchronization update request matches with the local clock value of reference base station 15B, reference base station 15B transmits a synchronization update response or acknowledgement, at 1024, to base station 15A. The synchronization update response generally comprises an indication that the synchronization was successful (e.g. a raised synchronization success flag) and possibly the local clock value of reference base station 15B.

Referring to FIG. 2B, if, at 1022 the clock value comprised in the synchronization update request does not match with the local clock value of reference base station 15B, reference base station 15B instead transmits, at 1028, a synchronization response, similar to synchronization response sent at 1012, which comprises the local time of base station 15B.

Referring to FIGS. 2A and 2B, once base station 15A receives either the synchronization update response or the second synchronization response, base station 15A stops the second timer at 1076.

At this point, if base station 15A receives a synchronization update response from reference base station 15B, base station 15A concludes that it is properly synchronized with reference base station 15B. Otherwise, if base station 15A receives a regular synchronization response from base station 15B, base station 15A again replaces, at 1030, its local clock value with the clock value comprised in the second synchronization response. This twice replaced clock value can be further adjusted for the transmission delay determined with the second timer.

Though not shown in FIG. 2B, base station 15A can send a new synchronization update request including the twice updated clock value to again verify that it is now properly synchronized. This validation process can be repeated until either synchronization is achieved or a predetermined number of failed attempts is reached.

In the present embodiment, the first and second timers can also be used to determine occurrences of time-outs. For instance, if base station 15A fails to receive any response from reference base station 15B after a predetermined time-out delay, generally settable by the network operator, base station 15A will retrieve another neighboring base station 15 from its internal list of neighboring base stations 15, and will transmit the clock synchronization request to that new neighboring reference base station 15. Notably, a time-out can occur when, for instance, the neighboring reference base station 15B has also lost its synchronization or is otherwise unavailable.

Referring now to FIG. 2C, in the event that reference base station 15B determines that there is no mismatch between the most recent clock value received in the clock synchronization request and the local clock value, at 1010, reference base station 15B transmits, at 1032, a clock synchronization failure notification to base station 15A. This clock synchronization failure notification generally comprises an indication that the most recent clock value of base station 15A is not corrupted according to reference base station 15B (e.g. a raised no loss of synchronization flag, a lowered alarm flag, etc.). The clock synchronization failure notification could also comprise addition information such as the local clock value of reference base station 1511. Such a scenario can happen when, for instance, base station 15A erroneously detects a loss of clock synchronization.

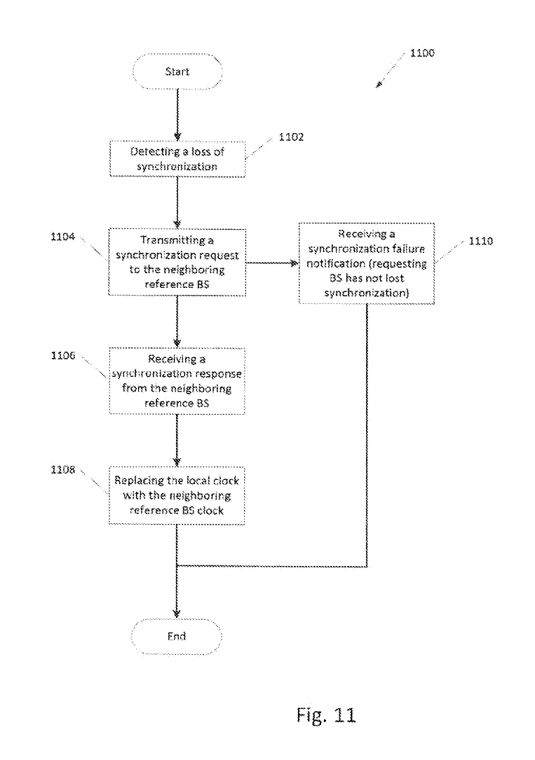

An embodiment of a method for synchronizing a communication node as implemented by a requesting base station 15, i.e. a base station 15 having possibly lost its clock synchronization, is illustrated by the flow chart 1100 depicted in FIG. 11.

In flow chart 1100, requesting base station 15 generally detects, at 1102, that it has lost clock synchronization. Then, at 1104, requesting base station 15 transmits a clock synchronization request to a neighboring reference base station 15. If reference base station 15 detects a mismatch between the clock value of requesting base station 15 and its own clock value, then, at 1106, requesting base station 15 receives a synchronization response from reference base station 15. Otherwise, requesting base station 15 receives, at 1110, a synchronization failure notification from the reference base station 15.

If requesting base station 15 receives the synchronization response from reference base station 15, it then replaces, at 1108, its local clock value with the clock value received in the synchronization response.

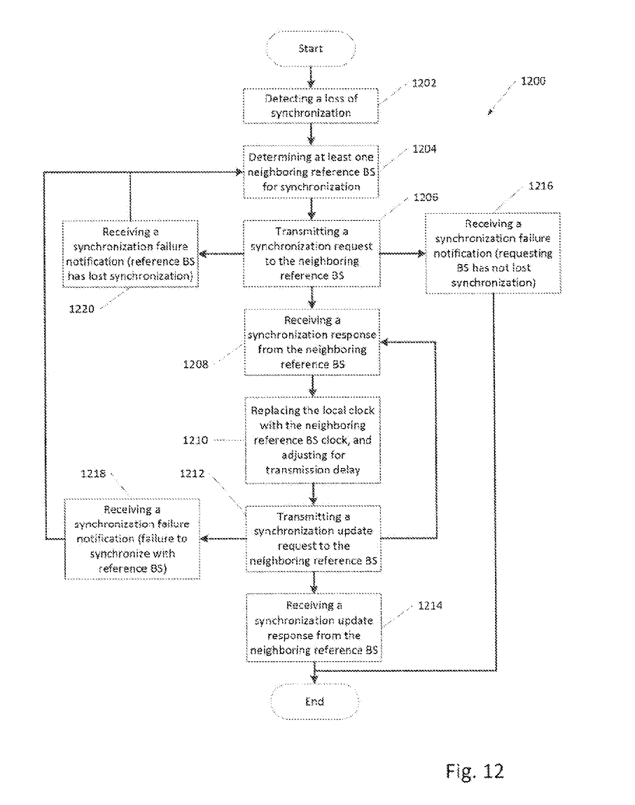

Another embodiment of a method for synchronizing a communication node as implemented by a requesting base station 15 is illustrated by the flow chart 1200 depicted in FIG. 12. Embodiment 1200 is similar to embodiment 1100 but comprises alternative and/or additional steps.

In flow chart 1200, requesting base station 15 generally detects, at 1202, that it has lost clock synchronization. Then, at 1204, it determines at least one neighboring reference base station 15 to contact for synchronization purposes. At 1206, requesting base station 15 transmits a clock synchronization request to the previously determined neighboring reference base station 15. As in embodiment 1100, if reference base station 15 detects a mismatch between the clock value of requesting base station 15 and its own clock value, then, at 1208, requesting base station 15 receives a synchronization response from reference base station 15. Otherwise, if no mismatch between the two clocks is detected, requesting base station 15 receives, at 1216, a synchronization failure notification from reference base station 15. At this point, since requesting base station 15 has not lost clock synchronization, it stops the clock synchronization procedure and resumes its normal operation.

If requesting base station 15 receives the synchronization response from reference base station 15, requesting base station 15 then replaces, at 1210, its local clock value with the clock value of reference base station 15, and typically further adjusts the replacement clock value to take into account the transmission delay between the transmission of the request and the reception of the response. In the present embodiment, the adjustment to the clock value generally involves adding half the transmission delay to the replacement clock value of reference base station 15.

In the present embodiment, requesting base station 15 further sends, at 1212, a synchronization update request to reference base station 15. The synchronization update request generally comprises the updated local clock of requesting base station 15.

If the updated clock value matches the local clock value of reference base station 15, then requesting base station 15 receives, at 1214, a synchronization update response which comprises an indication that synchronization was successful. Otherwise, the procedure loops back to 1208 where requesting base station 15 receives another synchronization response with the clock value of reference base station 15.

Requesting base station 15 can try to synchronize its local clock value using the local clock value of reference base station 15 for a predetermined number of times. In that sense, if requesting base station 15 fails to properly synchronize its local clock value with the clock value of reference base station 15, it will eventually receive, at 1218, a synchronization failure notification comprising an indication that synchronization with reference base station 15 has failed. At that point, the method will loop back to 1204 and requesting base station 15 will try again with another neighboring reference base station 15.

Should reference base station 15 have also lost its synchronization, requesting base station 15 will simply receive a synchronization failure notification comprising an indication that reference base station 15 has also lost its synchronization. At that point, the procedure will loop back to 1204 and requesting base station 15 will try again with another neighboring reference base station 15.

Optionally, requesting base station 15 can transmit, at the opportune time, a synchronization attack notification to all neighboring base stations 15. This synchronization attack notification generally comprises an indication that the requesting base station 15 is under a synchronization attack (e.g. a raised synchronization attack flag).

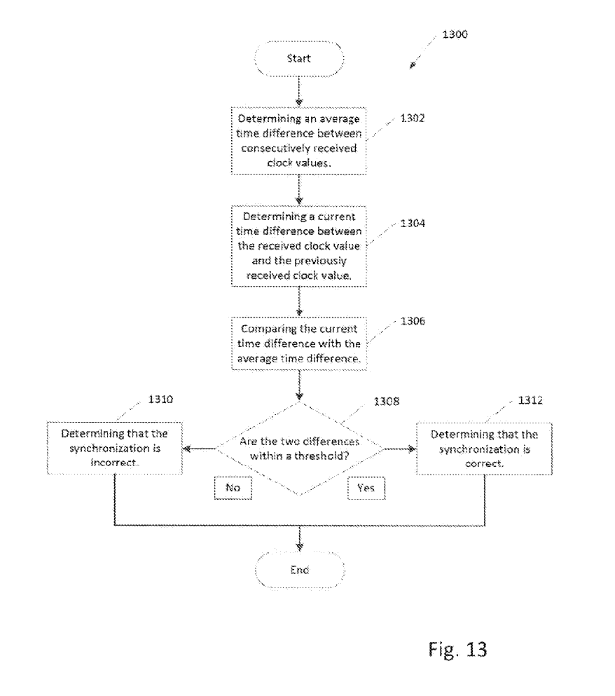

Referring now to FIG. 13, an embodiment of a method for detecting a loss of clock synchronization as implemented by a base station 15 is illustrated by the flow chart 1300.

To detect a loss of clock synchronization, a base station 15 starts by determining an average time difference between consecutively received clock values, at 1302. In other words, as base station 15 receives clock values from the GNSS satellites 30 at substantially regular intervals, it determines that average time difference between consecutive clock values. This determination of the average time difference can generally be performed while base station 15 is properly synchronized.

At 1304, base station 15 determines the current time difference, which is the time difference between the most current clock value and the prior clock value.

Then, at 1306, base station 15 compares the current time difference with the average time difference. If, at 1308, the current time difference differs from the average time difference beyond a predetermined threshold (e.g. a predetermined percentage, a predetermined range, etc.), base station 15 concludes, at 1310, that its clock synchronization is incorrect and that it has lost clock synchronization. Otherwise, base station 15 concludes, at 1312, that its clock synchronization is correct and thus that it has not lost clock synchronization.

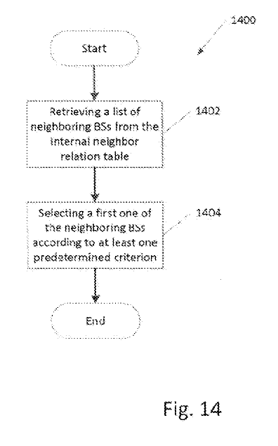

Referring now to FIG. 14, an embodiment of a method for determining a neighboring reference base station as implemented by a base station 15 is illustrated by the flow chart 1400.

At 1402, base station 15 retrieves a list of neighboring base stations 15 from its internal neighbor relation table. Alternatively, the list of neighboring base stations 15 could be retrieved from an external database.

Then, at 1404, base station 15 selects a first one of the neighboring base stations 15 based on at least one criterion. In some embodiments, the at least one criterion can include geographical proximity such that base station 15 will select the closest neighboring base station 15 first. In other embodiments, alternative and/or additional criteria can be used, e.g. indoor/outdoor location, signal quality, signal strength, average response time, etc.).

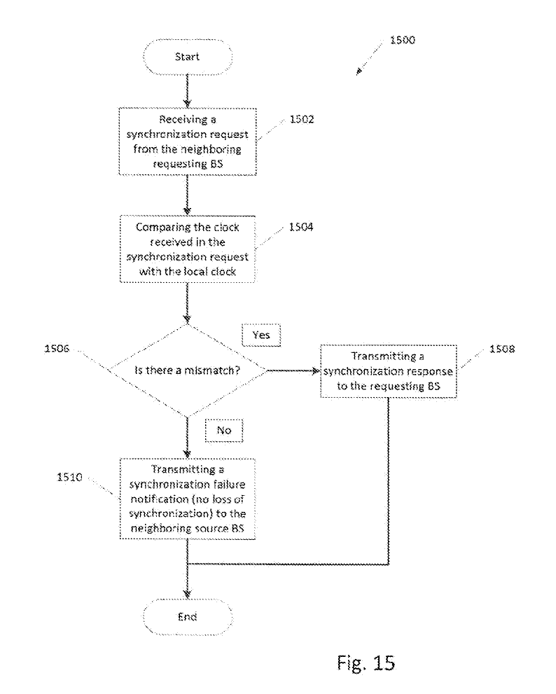

An embodiment of a method for synchronizing a communication node as implemented by a reference base station 15 is illustrated by the flow chart 1500 depicted in FIG. 15.

At 1502, reference base station 15 receives a clock synchronization request from a requesting base station 15 having possibly lost its clock synchronization. As indicated above, the clock synchronization request generally comprises the most recent (and possibly corrupted) local clock value of requesting base station 15.

Then, at 1504, reference base station 15 compares the received clock value with its own local clock value. Following the comparison, reference base station 15 then determines, at 1506, whether there is a mismatch between the received clock value and its local clock value.

If there is no mismatch (i.e. both clock values are synchronized), reference base station 15 transmits, at 1510, a clock synchronization failure notification to requesting base station 15, the clock synchronization failure notification generally comprising an indication that requesting base station 15 has not lost its clock synchronization.

Otherwise, if reference base station 15 determines that there is a mismatch, reference base station 15 transmits, at 1508, a clock synchronization response to requesting base station 15, the clock synchronization response comprising the local clock value of reference base station 15.

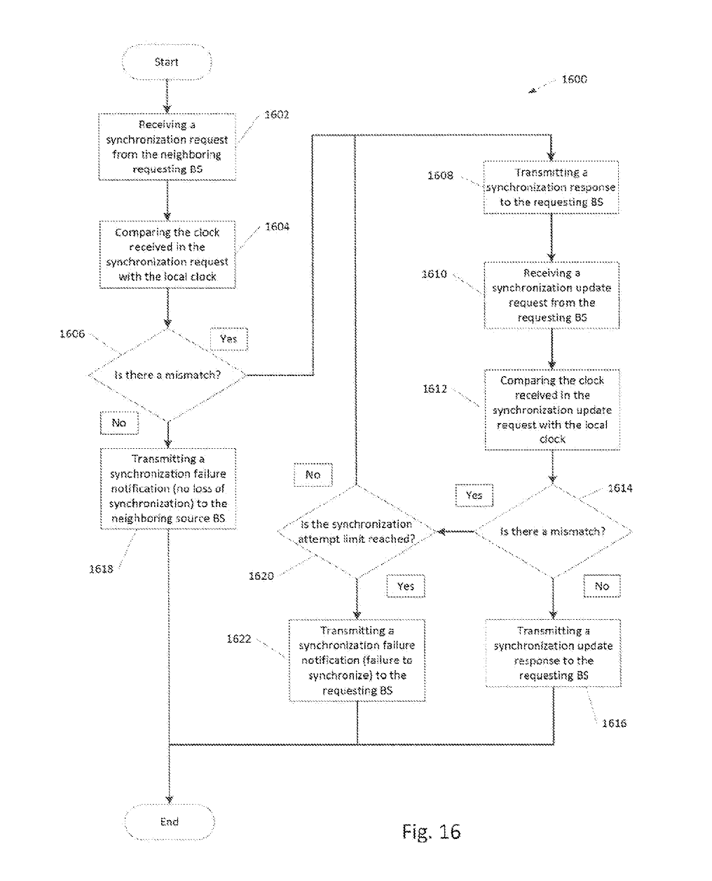

Another embodiment of a method for synchronizing a communication node as implemented by a reference base station 15 is illustrated by the flow chart 1600 depicted in FIG. 16. Embodiment 1600 is similar to embodiment 1500 but comprises alternative and/or additional steps.

Starting at 1602, reference base station 15 receives a clock synchronization request from a requesting base station 15 having possibly lost its clock synchronization. Again, the clock synchronization request generally comprises the most recent (and possibly corrupted) local clock value of requesting base station 15.

Then, at 1604, reference base station 15 compares the received clock value with its own local clock value. Pursuant to the comparison, reference base station 15 determines, at 1606, whether there is a mismatch between the received clock value and its local clock value.

If there is no mismatch, reference base station 15 transmits, at 1618, a clock synchronization failure notification to requesting base station 15, the clock synchronization failure notification generally comprising an indication that requesting base station 15 has not lost its clock synchronization.

If, however, reference base station 15 determines that there is a mismatch, reference base station 15 transmits, at 1608, a clock synchronization response to requesting base station 15, clock synchronization response comprising the local clock value of reference base station 15.

Then, reference base station 15 receives, at 1610, a clock synchronization update request from requesting base station 15, the clock synchronization update request generally comprising the updated clock value of requesting base station 15. At 1612, reference base station 15 compares the received updated clock value with its own local clock value to determine if there is a mismatch.

If there is no mismatch, reference base station 15 transmits, at 1616, a clock synchronization response or acknowledgement indicating that synchronization has succeeded.

Otherwise, if there is a mismatch, reference base station 15 determines, at 1620, whether reference base station 15 has reached the limit of synchronization attempts. This limit of synchronization attempts generally prevents reference base station 15 from trying indefinitely to provide synchronization to requesting base station 15.

If the limit is reached, reference base station 15 transmits, at 1622, a clock synchronization failure notification generally comprising an indication that synchronization has failed (e.g. a raised failed attempts limit reached flag).

If the limit is not yet reached, reference base station 15 loops back to 1608 and again transmits a synchronization response to requesting base station 15.

Optionally, reference base station 15 can transmit, at the opportune time, a synchronization attack notification to all neighboring base stations 15. This synchronization attack notification generally comprises an indication that requesting base station 15 is under a synchronization attack.

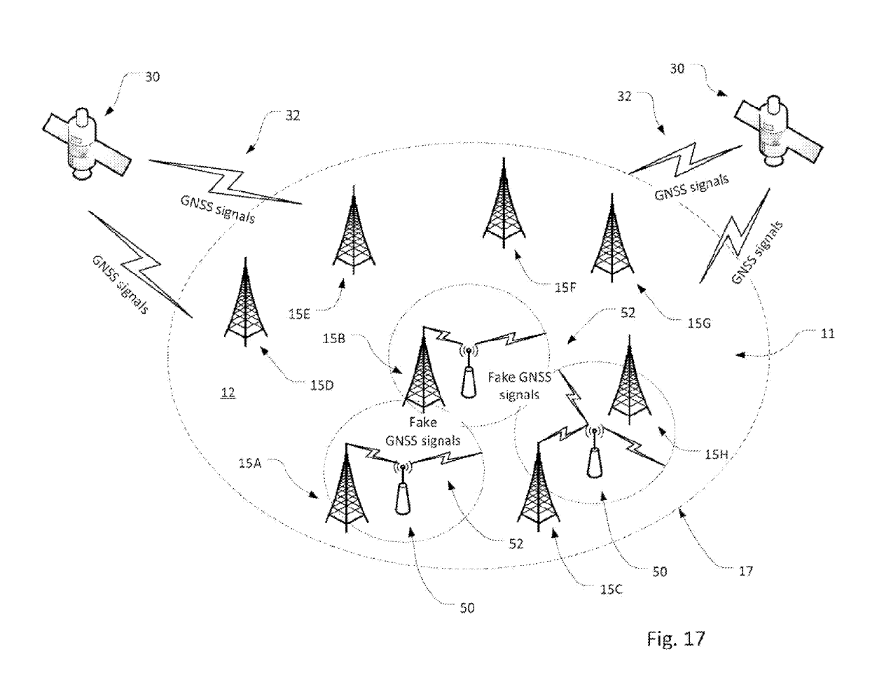

In the previously described embodiments, it was generally assumed that only one base station 15 was affected by the attacking transmitter 50, or more generally, by a loss of clock synchronization. It is however possible that more than one base station 15 be affected by one or more attacking transmitters 50. In that sense, FIG. 17 illustrates the same network 11 as FIG. 9 but in which several attacking transmitters 50 are present. When such a massive synchronization attack occurs, a base station 15 having lost its clock synchronization may attempt to synchronize with a neighboring reference base station 15 having also lost its own clock synchronization.

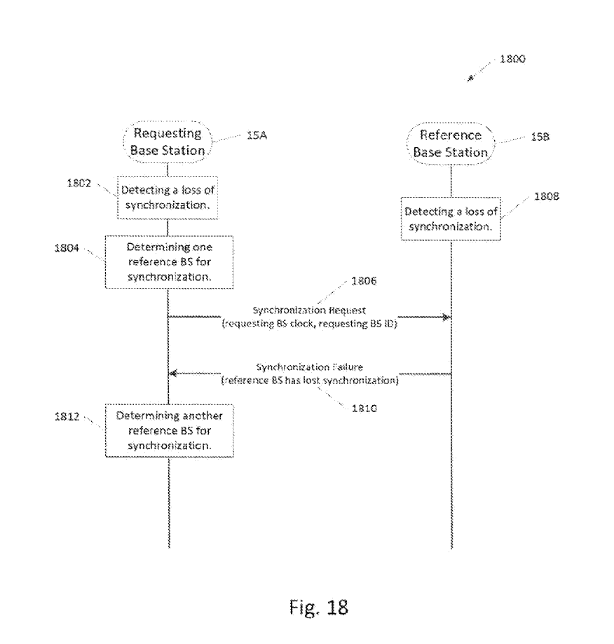

FIG. 18 illustrates an embodiment of an exemplary message flow and signaling diagram 1800 taking the above scenario into account.

At 1802, requesting base station 15A detects that it has lost its clock synchronization. At 1804, requesting base station 15A determines a neighboring reference base station 15 to contact (e.g. reference base station 15B) for synchronization purposes. Thereafter, at 1806, requesting base station 15A transmits a clock synchronization request to reference base station 15B. Before requesting base station 15A transmits its clock synchronization request however, reference base station 15B also detects, at 1808, that it has lost its clock synchronization.

Upon receiving the clock synchronization request, reference base station 15B replies, at 1810, with a clock synchronization failure notification which comprises an indication that reference base station 15B has also lost its clock synchronization (e.g. a raised flag).

Upon receiving such a clock synchronization failure notification, requesting base station 15A proceeds to select another neighboring reference base station 15 to contact for synchronization purposes.

Though not shown in FIG. 18, requesting base station 15A typically starts a timer when transmitting the clock synchronization request and stops the tinier when receiving a response from reference base station 15B. This timer can be used for adjusting the received clock value, if any, and/or to detect a time-out should reference base station 15B fail to respond.

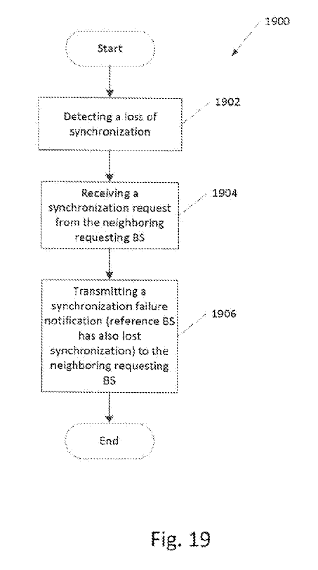

Another embodiment of a method for synchronizing a communication node as implemented by a reference base station 15 is illustrated by the flow chart 1900 depicted in FIG. 19.

At 1902, reference base station 15 detects a loss of its clock synchronization. Then, later, at 1904, reference base station 15 receives a clock synchronization request from a requesting base station 15. Upon receiving that request, reference base station 15 transmits, at 1906, a clock synchronization failure notification to requesting base station 15, the clock synchronization failure notification comprising an indication that reference base station 15 has lost its clock synchronization.

To perform one or more of the methods described in accordance with the present invention, embodiments of the base station 15 can comprise various modules.

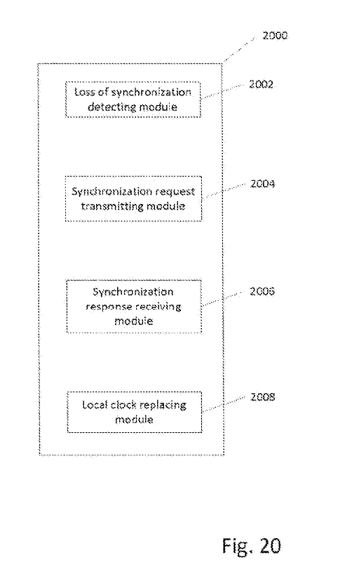

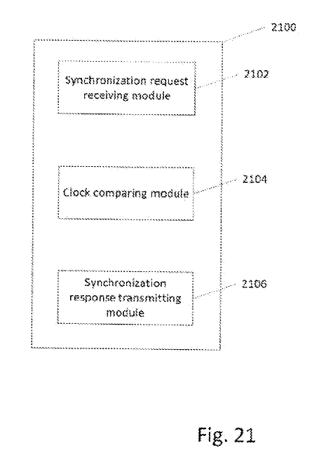

Such combinations or groups of modules are illustrated as embodiments 2000 and 2100 in FIGS. 20 and 21 respectively.

In FIG. 20, the group 2000 of modules generally comprises a loss of synchronization detecting module 2002 responsible for detecting the loss of synchronization of the local clock of the base station 15, a synchronization request transmitting module 2004 for transmitting a synchronization request to a neighboring reference base station 15, a synchronization response receiving module 2006 for receiving the synchronization response from the neighboring reference base station 15, and a local clock replacing module 2008 for replacing the local clock value of the base station 15 with the clock value of the neighboring reference base station 15.

In FIG. 21, the group 2100 of modules generally comprises a synchronization request receiving module 2102 for receiving a synchronization request from a requesting base station 15 having possibly lost its synchronization, a clock comparing module 2104 for comparing the clock received in the synchronization request with the local clock of reference base station 15, and a synchronization response transmitting module 2106 for transmitting a synchronization response to requesting base station 15.

Understandably, as a base station 15 can possibly act both as a requesting base station 15 and as a reference base station 15 depending on the circumstances, a base station 15 may comprise a combination of both groups of modules 2000 and 2100.

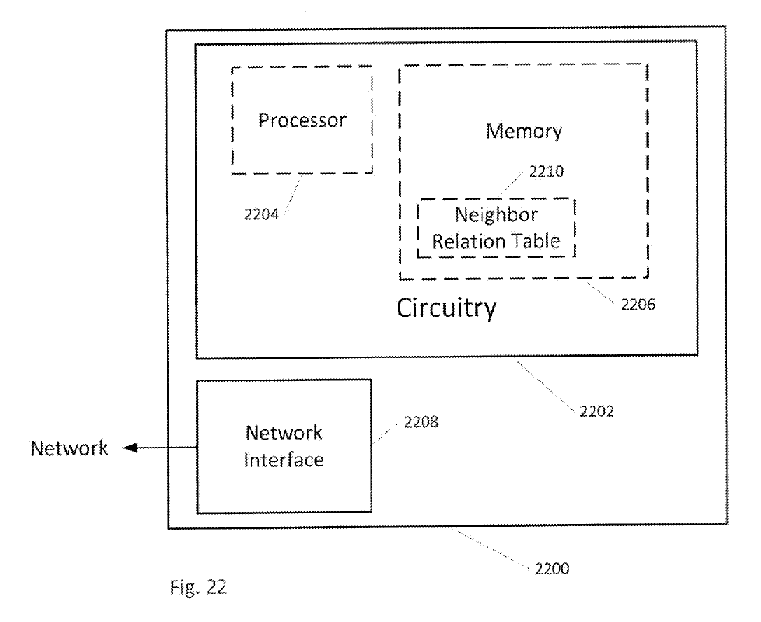

Referring now to FIG. 22, another embodiment of a base station 15 is illustrated as embodiment 2200. Without limitations, the embodiment 2200 illustrated in FIG. 22 could be used to implement any of the embodiments shown in FIGS. 2 to 6, 10A to 16, 18 and 19.

Embodiment 2200 of the base station 15 generally comprises circuitry 2202 (e.g. processor 2204 and memory 2206) and a communication interface 2208 operatively connected thereto. The communication interface 2208 provides access to various networks, including networks 10711 comprising the other base stations 15, and the GNSS satellites 30. The circuitry 2202 allows base station 15 to carry out the methods described (e.g. the methods described with reference FIGS. 2 to 6, 10A to 16, 18 and 19). In some embodiments, the base station 15 can comprise a neighbor relation table 2210 stored in the memory 2206.

Understandably, depending on the actual wireless communication technology used in networks 10/11, the base stations 15 could comprise alternative or additional components.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1) A method for synchronizing a communication node part of a cluster of communication nodes in a wireless communication network, the method comprising, at the communication node:
transmitting a clock synchronization request to a neighboring communication node part of the cluster, the synchronization request comprising a most recent local clock value of the communication node;
receiving a clock synchronization response from the neighboring communication node, the clock synchronization response comprising a clock value of the neighboring communication node;
replacing the most recent local clock value with the clock value of the neighboring communication node.

2) A method as claimed in claim 1, further comprising detecting a loss of clock synchronization of the most recent local clock value.

3) A method as claimed in claim 1, further comprising adjusting the clock value of the neighboring communication node with a transmission delay determined between the transmitting of the clock synchronization request and the receiving of the clock synchronization response.

4) A method as claimed in claim 3, further comprising:
starting a timer when transmitting the clock synchronization request;
stopping the timer when receiving the clock synchronization response; and
determining the transmission delay using the timer.

5) A method as claimed in claim 3, wherein the clock value of the neighboring communication node is adjusted by adding half of the transmission delay.

6) A method as claimed in claim 3, further comprising:
transmitting a second clock synchronization request to the neighboring communication node, the second synchronization request comprising the adjusted clock value;
receiving a second clock synchronization response from the neighboring communication node, the second clock synchronization response comprising a second clock value of the neighboring communication node;
replacing the previously adjusted local clock value with the second clock value of the neighboring node.

7) A method as claimed in claim 6, further comprising adjusting the second clock value of the neighboring node with a second transmission delay determined between the transmitting of the second clock synchronization request and the receiving of the second clock synchronization response.

8) A method as claimed in claim 7, further comprising:
starting a second timer when transmitting the second clock synchronization request;
stopping the second timer when receiving the second clock synchronization response; and
determining the second transmission delay using the second timer.

9) A method as claimed in claim 7, wherein the second clock value of the neighboring node is adjusted by adding half of the second transmission delay.

10) A method as claimed in claim 2, wherein the step of detecting a loss of synchronization comprises:
determining an average time difference between consecutively received clock values;
determining a current time difference between a most recently received clock value and a previously received clock value;
comparing the current time difference with the average time difference; and
detecting a loss of synchronization if the current time difference differs from the average time difference by more than a predetermined threshold.

11) A method as claimed in claim 10, wherein the clock values are received from an external source.

12) A method as claimed in claim 11, wherein the external source is a satellite-based navigation system.

13) A method as claimed in claim 1, further comprising:
retrieving a list of neighboring communication nodes from a neighbor relation table;
selecting one neighboring communication node among the list of neighboring communication nodes.

14) A method as claimed in claim 2, wherein the communication node is under a synchronization attack, and wherein the method further comprises:
receiving a corrupted clock value from an attacking transmitter.

15) A method as claimed in claim 14, further comprising transmitting a synchronization attack message to all neighboring communication nodes.

16) A method as claimed in claim 14, further comprising blocking a reception of further corrupted clock values from the attacking transmitter.

17) A communication node comprising:
a communication interface;
circuitry operatively connected to the communication interface and adapted to:
cause the communication interface to transmit a clock synchronization request to a neighboring communication node, the synchronization request comprising a most recent local clock value of the communication node;
receive a clock synchronization response from the neighboring communication node via the communication interface, the clock synchronization response comprising a clock value of the neighboring communication node;
replace the most recent local clock value with the clock value of the neighboring communication node.

18) A communication node as claimed in claim 17, wherein the circuitry is further adapted to detect a loss of clock synchronization of the most recent local clock value.

19) A communication node as claimed in claim 17, wherein the circuitry is further adapted to adjust the clock value of the neighboring communication node with a transmission delay determined between the transmission of the clock synchronization request and the reception of the clock synchronization response.

20) A communication node as claimed in claim 19, wherein the clock value of the neighboring communication node is adjusted by adding half of the transmission delay.

21) A communication node as claimed in claim 18, wherein the circuitry is further adapted to:
determine an average time difference between consecutively received clock values;
determine a current time difference between a most recently received clock value and a previously received clock value;
compare the current time difference with the average time difference; and
detect a loss of synchronization if the current time difference differs from the average time difference by more than a predetermined threshold.

22) A communication node as claimed in claim 17, wherein the circuitry is further adapted to:
retrieve a list of neighboring communication nodes from a neighbor relation table;
select one neighboring communication node among the list of neighboring communication nodes.

23) A communication node as claimed in claim 17, wherein the circuitry comprises a processor and memory.

24) A method for synchronizing a first communication node part of a cluster of communication nodes in a wireless communication network, the method comprising, at a second communication node part of the cluster:
receiving a clock synchronization request from the first communication node, the synchronization request comprising a clock value of the first communication node;
transmitting a clock synchronization response to the first communication node, the clock synchronization response comprising a local clock value.

25) A method as claimed in claim 24, further comprising:
determining if the clock value of the first communication node differs from the local clock value beyond a predetermined threshold;
as a function of the determination, transmitting the clock synchronization response to the first communication node, the clock synchronization response comprising the local clock value, if the clock value of the first communication node differs from the local clock value beyond the predetermined threshold, or transmitting a clock synchronization rejection to the first communication node if the clock value of the first communication node does not differ from the local clock value beyond the predetermined threshold.

26) A method as claimed in claim 25, further comprising, after transmitting the clock synchronization response to the first communication node:
receiving a second clock synchronization request from the first communication node, the second clock synchronization request comprising a second clock value of the first communication node, the second clock value of the first communication node being the previously transmitted local clock value of the second communication node adjusted for a transmission delay;
transmitting a second clock synchronization response to the first communication node, the second clock synchronization response comprising a second local clock value.

27) A method as claimed in claim 25, further comprising transmitting a synchronization attack message to all neighboring communication nodes if, as a function of the determination, the clock value of the first communication node differs from the local clock value beyond the predetermined threshold.

28) A method for synchronizing a first communication node part of a cluster of communication nodes in a wireless communication network, the method comprising, at a second communication node part of the cluster:
detecting a loss of clock synchronization of a local clock value;
receiving a clock synchronization request from the first communication node, the synchronization request comprising a clock value of the first communication node;
transmitting a clock synchronization failure notification to the first communication node.

29) A communication node comprising:
a communication interface;
circuitry operatively connected to the communication interface and adapted to:
receive a clock synchronization request from a requesting communication node via the communication interface, the synchronization request comprising a clock value of the requesting communication node;
cause the communication interface to transmit a clock synchronization response to the requesting communication node, the clock synchronization response comprising a local clock value.

30) A communication node comprising:
a communication interface;
circuitry operatively connected to the communication interface and adapted to:
receive a clock synchronization request from a requesting communication node via the communication interface, the synchronization request comprising a clock value of the requesting communication node;
determine if the clock value of the requesting communication node differs from a local clock value beyond a predetermined threshold;
as a function of the determination, cause the communication interface to transmit a clock synchronization response to the requesting communication node, the clock synchronization response comprising the local clock value, if the clock value of the requesting communication node differs from the local clock value beyond the predetermined threshold, or cause the communication interface to transmit a clock synchronization rejection notification to the requesting communication node if the clock value of the requesting communication node does not differ from the local clock value beyond the predetermined threshold.

31) A communication node comprising:
a synchronization request transmitting module for transmitting a synchronization request to a neighboring communication node;
a synchronization response receiving module for receiving a synchronization response from the neighboring communication node; and
a local clock replacing module for replacing the local clock value of the communication node with a clock value of the neighboring communication node.

32) A communication node as claimed in claim 31, further comprising:
a loss of synchronization detecting module for detecting a loss of synchronization of a local clock value of the communication node.

33) A communication node comprising:
a synchronization request receiving module for receiving a synchronization request from a requesting communication node;
a synchronization response transmitting module for transmitting a synchronization response to the requesting communication node.

34) A communication node as claimed in claim 33, further comprising:
a clock comparing module for comparing a clock value received in the synchronization request with the local clock value of the communication node.
